(19) United States
(12) Patent Application Publication
(10) Pub. No.: US 2014/0323109 A1
(43) Pub. Date: Oct. 30, 2014

(54) CELLULAR COMMUNICATION BLOCKING DEVICE

(71) Applicants: Terry Spangler, Page, AZ (US); Harold Schafer, Page, AZ (US)

(72) Inventors: Terry Spangler, Page, AZ (US); Harold Schafer, Page, AZ (US)

(21) Appl. No.: 13/871,418

(22) Filed: Apr. 26, 2013

(51) Int. Cl. H04W 4/00

(52) U.S. Cl. CPC H04W 4/008
USPC 455/418

(57) ABSTRACT

A system for cellular communication disablement comprising: a cellular blocking device, where the cell blocking device transmits a blocking signal to block cellular communication in a localized area; leads extending from the blocking device, where the leads engage electronic indicators of a vehicle; and active signals over the leads indicating the vehicle's transmission position, wherein the cell blocking device becomes active upon receipt of active transmission signals. The active transmission signals may indicate placement of the vehicle's transmission in either park, drive, reverse or neutral. Any active signals indicating placement of the vehicle's transmission into drive or reverse causes the cell blocking device to become active.

### BACKGROUND OF THE INVENTION

1. Field of Invention

The present invention relates to a cellular communications blocking device that enables a user to block all cellular communications within a moving vehicle.

2. Description of Related Art

As is well known in this modern society many people use cellphones and the use of cellphone communications has proliferated to all sorts of consumers allowing them to access cellphone communications in various locations and coverage areas formerly unavailable. In particular, many individuals keep a cellphone in their possession at all times and therefore are constantly able to receive communications via the cellphone. However one drawback to cellphone communications is the distraction of the user, if the user is operating a vehicle or doing other activities. It is especially important to avoid distraction while operating a vehicle to avoid vehicular accidents. Some states have banned the use of cellphones while driving. Others have certain limitations on use of cellphones while driving. Consequently, it would be advantageous to have a device that could essentially block or prohibit the ability to receive or transmit cell phone communications in a moving vehicle. Such a device could increase the safety of vehicle operation and therefore eliminate a major distraction for a driver, in particular cellphone usage.

### SUMMARY OF INVENTION

The present invention relates to a system for cellular communication disablement comprising: a cellular blocking device, where the cell blocking device transmits a blocking signal to block cellular communication in a localized area; leads extending from the blocking device, where the leads engage electronic indicators of a vehicle; and active signals over the leads indicating the vehicle's transmission position, wherein the cell blocking device becomes active upon receipt of active transmission signals. The active transmission signals may indicate placement of the vehicle's transmission in either park, drive, reverse or neutral. Any active signals indicating placement of the vehicle's transmission into drive or reverse causes the cell blocking device to become active.

### BRIEF DESCRIPTION OF DRAWINGS

FIG. 1 depicts an electronic cell-phone blocking device in accordance with the present invention.

### DETAILED DESCRIPTION

The present invention relates to a cellphone communications blocking device that prohibits the transmission of cellphone communications within a moving vehicle when activated. The present invention therefore eliminates all cellphone communications and prevents the transmission of cellular communications during the operation of the vehicle. The blocking device may be activated by vehicle motion or transmission activity. This blocking device therefore may be integrated with the electronics of a vehicle so that the cellphone blocking system activates automatically once the vehicle is engaged in drive or reverse.

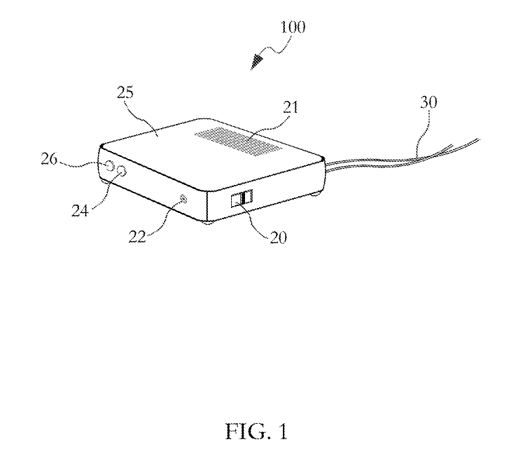

In reference to FIG. 1, a cell phone blocking device 100 is depicted. The cell phone blocking device 100 includes transmission leads 30. These transmission leads 30 are engaged or integrated with the electronics of the vehicle. Although not shown these leads 30 provide a means to indicate whether the vehicle is in an active gear and therefore capable of being indicating whether the vehicle's transmission is in drive or reverse. Further these leads 30 provide an indication of whether the vehicle is in park or a neutral position. Once signals are sent through the leads 30 indicating whether the vehicle is in an active transmission gear, a blocking signal is emitted from the cell phone blocking device 100 that blocks cellphone communications while the vehicle remains in active transmission. Once the vehicle is placed in an inactive transmission, i.e. park or neutral, the transmission of the cell phone blocking signal is deactivated.

The cell phone blocking device 100 includes some various general components such as a power switch 20 that enables the user to actively switch the device between on or off position and a power light 22 that indicates that cellphone blocking is active. Further the blocking device 100 includes a deactivating button 26 that deactivates the blocking device in order for an individual to make a 911 call. Further a reactivating button 24 is available that reactivates the cell blocking device 100 once the emergency call has been addressed. One additional feature of the cellular blocking device 100 is a venting system 21 that allows for the venting of the internal circuitry associated with the cellphone blocking device.

The cellphone blocking device in accordance with the present invention is designed for use with a moving vehicle such as a car, truck, van or other type of moving vehicle. This cell phone blocking device therefore provides a means to disable cellphone communications while the vehicle is in a active transmission gear. The device may be mounted inside or under the dash of the vehicle and connected to electronic indicators associated with the transmission engagement and selection. The system triggers off an active transmission gear and therefore prevents the cellphone communications while the vehicle is in operation. The instant invention has been shown and described in what it considers to be the most practical and preferred embodiments. It is recognized, however, that departures may be made there from within the scope of the invention and that obvious modifications will occur to a person skilled in the art.

What is claimed is:

1. A system for cellular communication disablement comprising:
a. a cellular blocking device, where the cell blocking device transmits a blocking signal to block cellular communication in a localized area;
b. leads extending from the blocking device, where the leads engage electronic indicators of a vehicle; and
c. active signals over the leads indicating the vehicle's transmission position, wherein the cell blocking device becomes active upon receipt of active transmission signals.

2. The system according to claim 1 where said active transmission signals indicate placement of the vehicle's transmission in at least one of park, drive, reverse and neutral.

3. The system according to claim 2, where said active signals include placement of the vehicle's transmission into drive and reverse.

4. The system according to claim 1, where the cell phone blocking device includes a power switch where the power switch enables a user to actively switch the cell phone blocking device between an on or off position and a power light, where the power light indicates that the cell phone blocking is active.

5. The system according to claim 4, where the cell phone blocking device includes a deactivating button, where the deactivating button deactivates the cell blocking device and a reactivating button, where the reactivating button reactivates the cell blocking device.
